(19) United States
(12) Patent Application Publication
(10) Pub. No.: US 2023/0228602 A1
(43) Pub. Date: Jul. 20, 2023

(54) ENERGY METERING SYSTEM FOR A FAN COIL

(71) Applicant: International Environmental Corporation, Oklahoma City, OK (US)

(72) Inventors: Xiaoming ZHU, Coppell, TX (US); Roger Lee BOYDSTUN, Oklahoma City, OK (US); Travis Wayne MARTIN, Moore, OK (US); James Wallace BROWN, Edmond, OK (US)

(21) Appl. No.: 17/648,361

(22) Filed: Jan. 19, 2022

(51) Int. Cl. G01F 1/66; G01F 1/667

(52) U.S. Cl. CPC G01F 1/662; G01F 1/667

(57) ABSTRACT

Flow meters are disclosed that provide improved measurements of fluid flowing through fan coils. A flow meter includes a body that defines an inlet, an outlet, and a flow path extending along a longitudinal axis between the inlet and the outlet. The flow meter also includes transducers coupled to the body and exposed to the flow path defined by the body. The transducers are configured to transmit and receive a signal travelling through the flow path to measure a flow rate of fluid of the fan coil. The flow meter also includes one or more reflectors coupled to the body and exposed to the flow path defined by the body. Each of the one or more reflectors has a flat reflective surface that is exposed to the flow path and is configured to reflect the signal to relay the signal between the transducers.

### TECHNICAL FIELD

The instant disclosure relates generally to energy meters and, more particularly but without limitation, to energy metering systems for fan coils.

### BACKGROUND

Heating, ventilation, and air conditioning (HVAC) systems are used to regulate the temperature of air in a space. Some HVAC systems have a fan coil unit and connected ductwork to regulate the air within the space. Fan coil units typically include a heat exchanging coil and a fan to alter the air temperature within the space.

Some fan coil units have meters, such as energy meters or flow meters, to monitor the performance of the fan coil units. Such meters may provide data to a corresponding thermostat to facilitate the HVAC system in regulating the air in the space to a desired location.

Many energy meters have a relatively large footprint and expensive, thereby making it difficult and expensive to incorporate within a small cavity of a fan coil unit. Additionally, many flow meters rely on components inserted into the flow path of the fluid to measure the flow rate of the fluid. Such inserted objects may themselves alter the flow rate being measured, thereby making it difficult to accurately measure the flow rate of the fluid.

### SUMMARY

Disclosed are various embodiments of energy metering systems and methods of operating the energy metering systems with fan coils.

An example flow meter of an exemplary energy metering system disclosed herein for a fan coil comprises a body that defines an inlet, an outlet, and a flow path extending along a longitudinal axis between the inlet and the outlet. The flow meter also comprises transducers coupled to the body and exposed to the flow path defined by the body. The transducers are configured to transmit and receive a signal travelling through the flow path to measure a flow rate of fluid of the fan coil. The flow meter also comprises one or more reflectors coupled to the body and exposed to the flow path defined by the body. Each of the one or more reflectors has a flat reflective surface that is exposed to the flow path and is configured to reflect the signal to relay the signal between the transducers.

In some examples, the signal transmitted and received by the transducers is an ultrasonic signal.

In some examples, the transducers include a transmitter and a receiver. The transmitter is configured to transmit the signal in a direction toward a first of the one or more reflectors. The receiver is configured to receive the signal reflected by each of the one or more reflectors.

Some examples further comprise a controller in communication with the transducers. The controller is configured to determine the flow rate of the fluid based on a measurement of a travel time of the signal between the transducers. In some such examples, to prevent interference from affecting the measurement of the travel time of the signal, the controller is configured to delay sampling of the signal by a first of the transducers to start a predetermined period of time after a second of the transducers sends the transmits the signal.

In some examples, the flat reflective surface of each of the one or more reflectors extends parallel to the longitudinal axis of the body.

In some examples, each of the transducers is oriented at a predefined angle relative to the longitudinal axis. The predefined angle of each of the transducers is based on the material composition of the fluid and the one or more reflectors to enable total internal reflection of the signal off each of the one or more reflectors. In some such examples, each of the one or more reflectors is formed of copper and the predefined angle at which each of the transducers is oriented is greater than about 45 degrees.

In some examples, the one or more reflectors include three reflectors each of which is positioned between the transducers relative to the longitudinal axis. The three reflectors are configured to reflect the signal in sequence to form a W-shaped signal path of the signal between the transducers.

In some examples, none of the transducers and none of the one or more reflectors are positioned within or extend into the flow path defined by the body.

Another embodiment of a flow meter of the instant disclosure includes a body that defines an inlet, an outlet, a flow path extending along a longitudinal axis between the inlet and the outlet, transducer openings, and reflector openings. Transducers are positioned within the transducer openings to expose the transducers to the flow path defined by the body. The transducers are removably coupled to the body. The transducers are configured to transmit and receive a signal travelling through the flow path to measure a flow rate of fluid of the fan coil. Reflectors are positioned within the reflector openings to expose the reflectors to the flow path defined by the body. The reflectors are removably coupled to the body. Each of the reflectors has a flat reflective surface that is exposed to the flow path and is configured to reflect the signal to relay the signal between the transducers. Plates are removably coupled to the body to removably couple the transducers and the reflectors to the body.

Some examples further include seals each of which is configured to form a sealed coupling between the body and one of the transducers or one of the reflectors.

In some examples, at least one of the plates defines a flat outer surface to enable the body to securely rest on an adjacent object for support.

In some examples, the body further includes a first wall and second walls opposite the first wall. The second walls define the transducer openings. In some such examples, the first wall defines two of the reflector openings into which two of the reflectors extend and the second walls define one of the one or more reflector openings, and the reflectors include three reflectors that are positioned relative to the transducers to form a W-shaped signal path of the signal between the transducers. In some such examples, the plates include first and second plates configured to couple the transducers to respective walls of the second walls. Further, in some such examples, the plates include a third plate configured to couple one of the reflectors to a respective one of the second walls and a fourth plate configured to couple two of the reflectors to the first wall.

Another embodiment of a flow meter of the instant disclosure includes a cylindrical body that defines an inlet, an outlet, a flow path extending along a longitudinal axis between the inlet and the outlet, transducer openings, and reflector openings. Transducers are positioned within the transducer openings to expose the transducers to the flow path defined by the body. The transducers are removably coupled to the body. The transducers are configured to transmit and receive a signal travelling through the flow path to measure a flow rate of fluid of the fan coil. Reflectors are positioned within the reflector openings to expose the reflectors to the flow path defined by the body. The reflectors are removably coupled to the body. Each of the reflectors has a flat reflective surface that is exposed to the flow path and is configured to reflect the signal to relay the signal between the transducers.

In some examples, the reflectors are threadably received within the transducer openings to couple the reflectors to the body.

Some examples further include caps threadably coupled to the body to removably couple the transducers to the body.

### BRIEF DESCRIPTION OF THE DRAWINGS

FIG. 1 is a perspective view of an embodiment of a flow meter of the instant disclosure.

FIG. 2 is an exploded perspective view of the flow meter of FIG. 1.

FIG. 3 is another exploded perspective view of the flow meter of FIG. 1.

FIG. 4 is a perspective cross-sectional view of the flow meter of FIG. 1.

FIG. 5 is a side cross-sectional view of the flow meter of FIG. 1.

FIG. 6 is a top view of the flow meter of FIG. 1.

FIG. 7 is a bottom view of the flow meter of FIG. 1.

FIG. 8 is a side view of the flow meter of FIG. 1.

FIG. 9 is an end view of the flow meter of FIG. 1.

FIG. 10 is a perspective view of another embodiment of a flow meter of the instant disclosure.

FIG. 11 is an exploded perspective view of the flow meter of FIG. 10.

FIG. 12 is another exploded perspective view of the flow meter system of FIG. 10.

FIG. 13 is a perspective cross-sectional view of the flow meter system of FIG. 10.

FIG. 14 is a side cross-sectional view of the flow meter system of FIG. 10.

FIG. 15 is a top view of the flow meter system of FIG. 10.

FIG. 16 is a bottom view of the flow meter system of FIG. 10.

FIG. 17 is a side view of the flow meter system of FIG. 10.

FIG. 18 is an end view of the flow meter system of FIG. 10.

FIG. 19 is a schematic of electrical components of an embodiment of an energy metering system of the instant disclosure.

FIG. 20 is a diagram of a propagation path an ultrasonic signal used to measure a flow rate of the flow meter of FIG. 1.

FIG. 21 is a chart depicting measurement resolutions of various flow meter configurations.

### DETAILED DESCRIPTION

Although the figures and the instant disclosure describe one or more embodiments of a heat pump system, one of ordinary skill in the art would appreciate that the teachings of the instant disclosure would not be limited to these embodiments. It should be appreciated that any of the features of an embodiment discussed with reference to the figures herein may be combined with or substituted for features discussed in connection with other embodiments in this disclosure.

The instant disclosure provides embodiments with improved measuring and installation capabilities for flow meters of fan coils. Embodiments of an energy metering system of the instant disclosure enables a controller to anticipate cooling and heating loads of a building having multiple zones, each with a fan coil or other HVAC system deployed therein and respond and/or optimize the operation of one or more fan coils accordingly. As the sun rises, for example, the zones of the building exposed to direct sunlight and/or nearest the rising sun may create a demand for cooling of those zones before the other zones. One or more controllers associated with the energy metering systems of the instant disclosure may be programmed to respond to that demand and initiate a cooling program for one or more fan coils before the zones require the cooled air to ensure that sufficient cooling capacity exists for those zones. The one or more controllers may operate autonomously by being programmed with a clock and a calendar while having access to historical outdoor and indoor/zonal temperatures that are retrievable from memory and/or real-time weather forecasts to autonomously initiate the cooling program. The foregoing may also be the same for heating loads caused by the setting sun, for example.

The flow meters of the instant disclosure are configured to accurately measure the flow rate of fluid flowing through the fan coil without inserting any disruptive objects into the corresponding flow path. The flow meters of the instant disclosure also have a relatively small footprint and are shaped to be easily installed onto or within a fan coil.

Embodiments of a flow meter of the instant disclosure includes a body that is configured to securely couple to a portion of the fan coil. The body defines a flow path through which fluid is to flow, and the body enables positioning of the flow meter longitudinally inline with the conduit conveying the fluid for which the flowrate is to be measured. Transducers are coupled to the body and exposed to the flow path. One or more reflectors are also coupled to the body and exposed to the flow path defined by the body. As used herein, a “reflector” refers to a structure configured to fully reflect an audio signal transmitted by an audio signal source, such as a transducer. One of the transducers is configured to transmit a signal, such as an audio signal, through the flow path. Another of the transducers is configured to receive the audio signal that travelled through the flow path. Each of the one or more reflectors has a flat reflective surface that is exposed to the flow path and is configured to reflect the audio signal to relay the signal between the transducers. As used herein, a “flat” surface refers to a surface that extends along a two-dimensional plane. The flow rate of the fluid is determined, at least in part, based on a measured travel time of the audio signal between the transducers. Embodiments of a flow meter of the instant disclosure enables replacement of any of the transducers without requiring removal of the flow meter from the fluid conduit to which it is connected. However, if removal of the flow meter is desired, embodiments of a flow meter of the instant disclosure enables the flow meter to be easily unscrewed or uncoupled from both of its ends from the conduit to which the flow meter is connected.

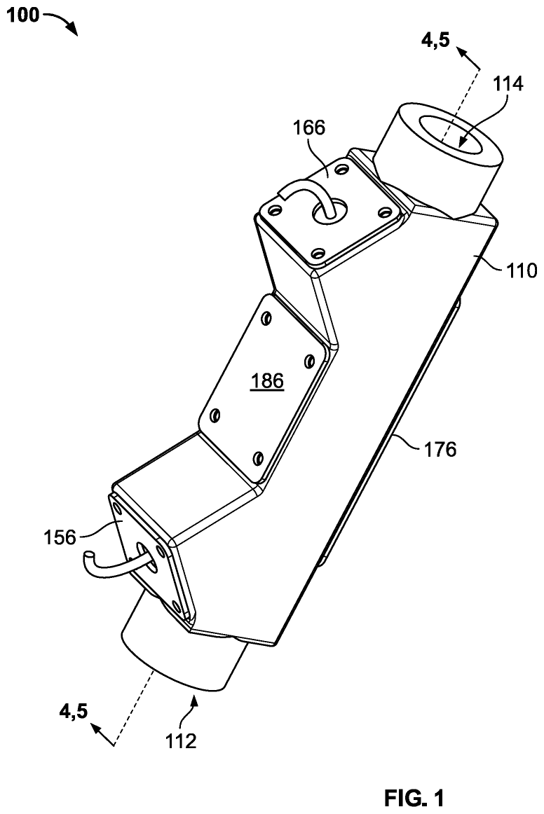

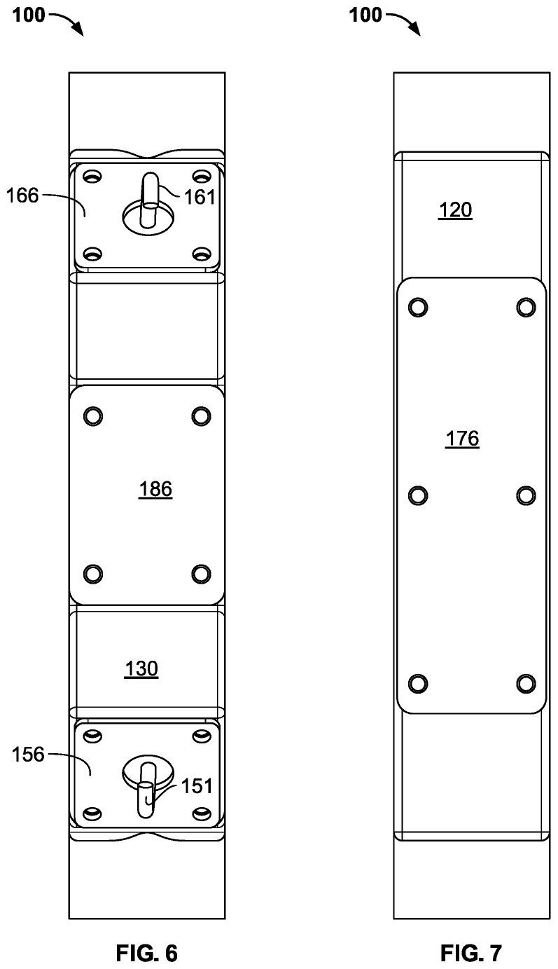

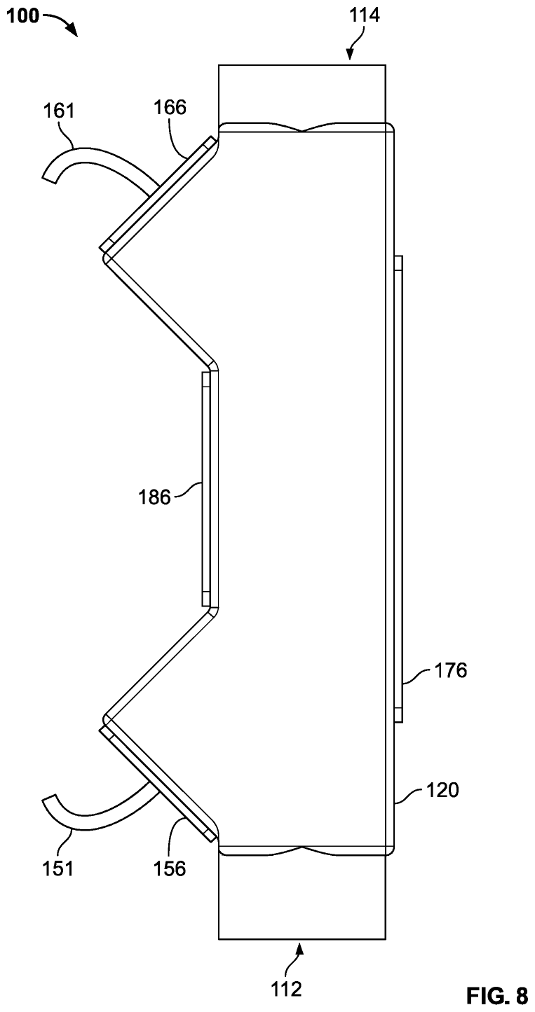

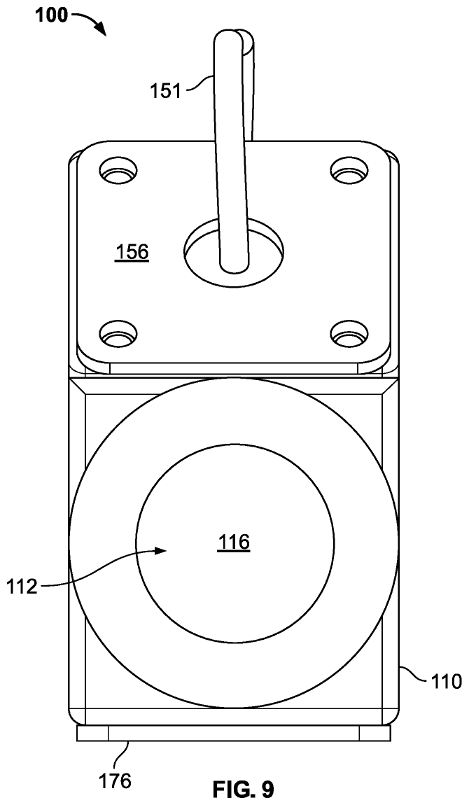

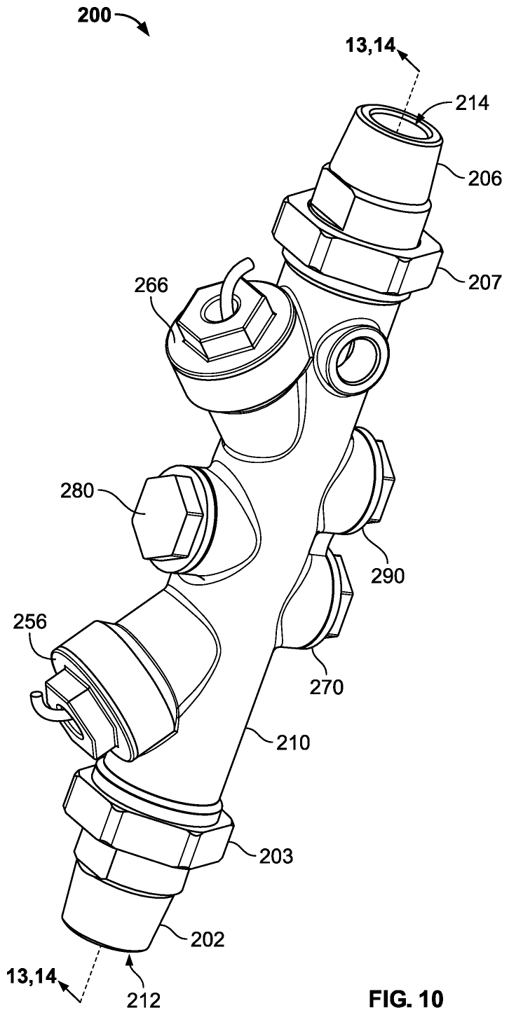

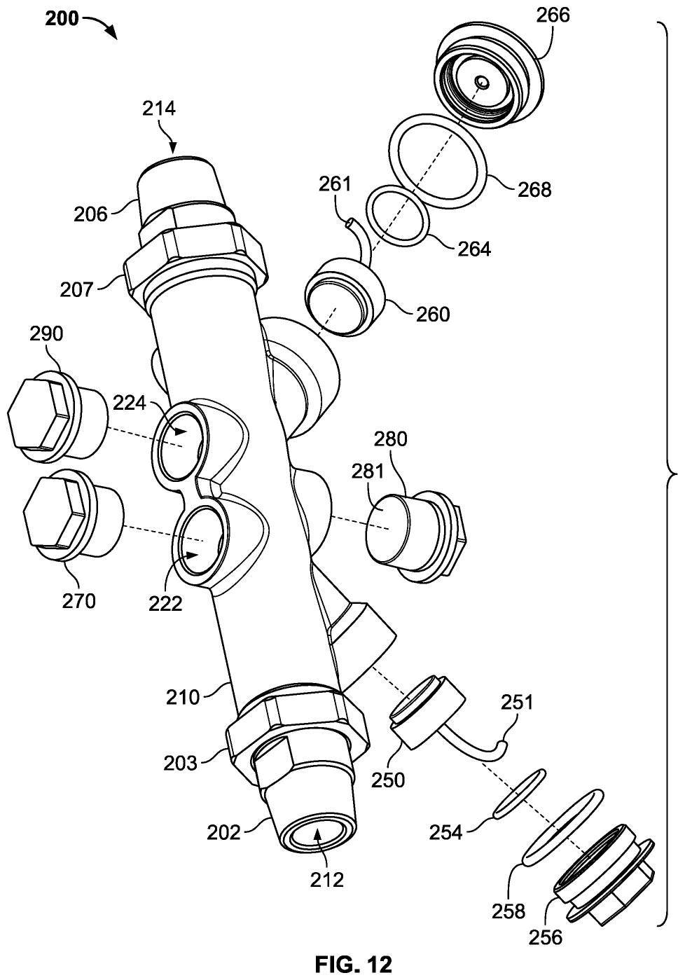

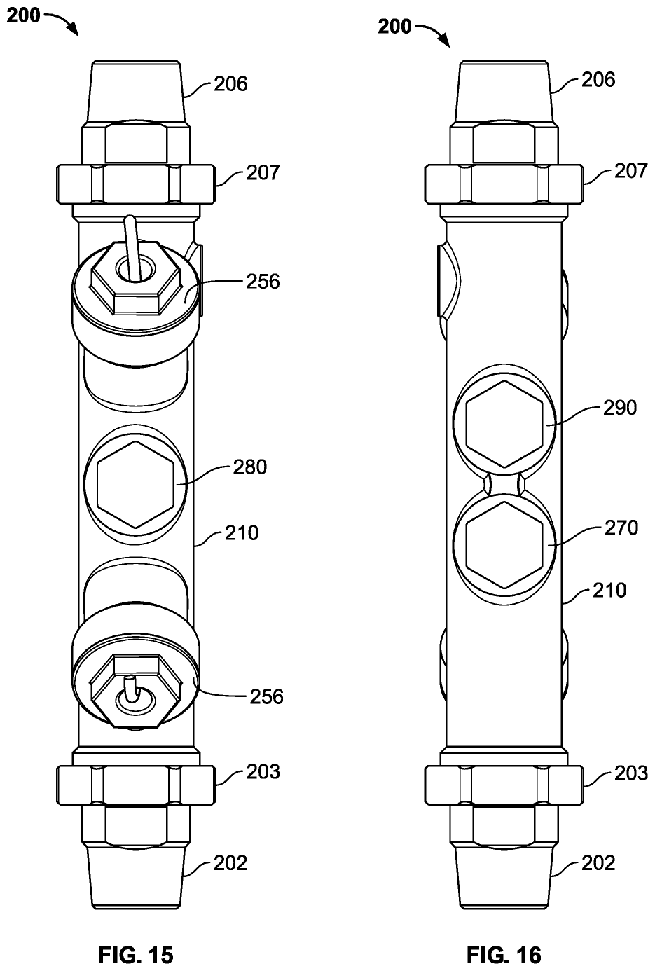

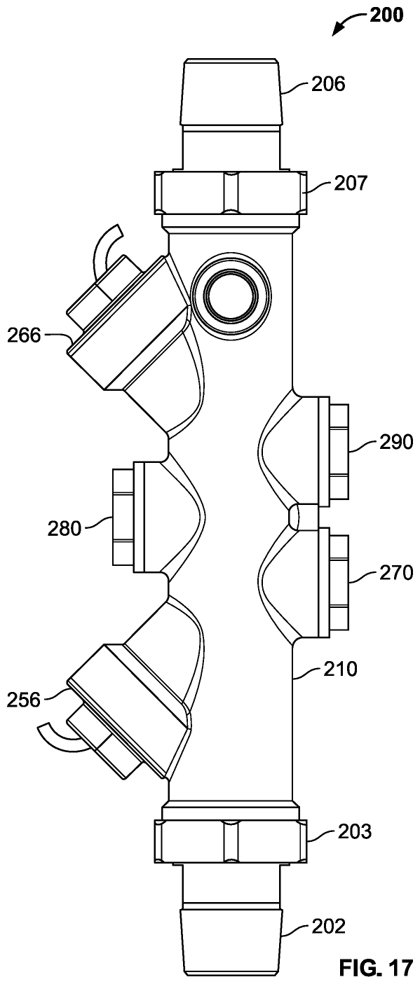

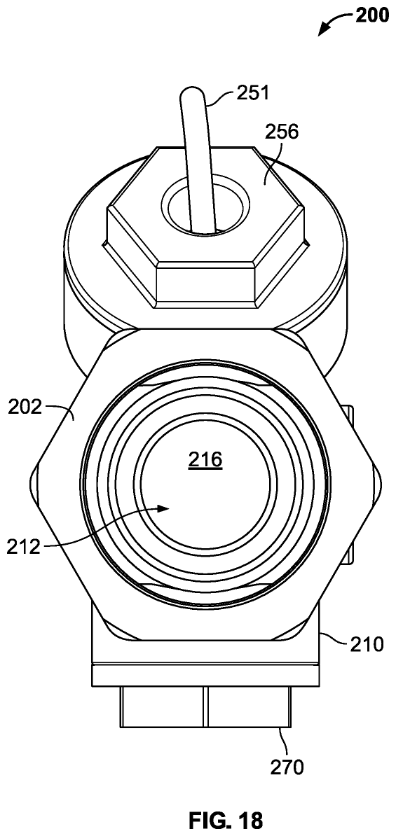

Turning now to the drawings, FIGS. 1-18 show various embodiments of a flow meter that are configured to measure the flow rate of a heat transfer fluid flowing through a fan coil. For example, FIGS. 1-9 depict an example flow meter 100, FIGS. 10-18 depict a flow meter 200.

In the embodiment of FIGS. 1-9, the flow meter 100 includes a body 110. The flow meter also includes transducers 150, 160 and reflectors 170, 180, 190.

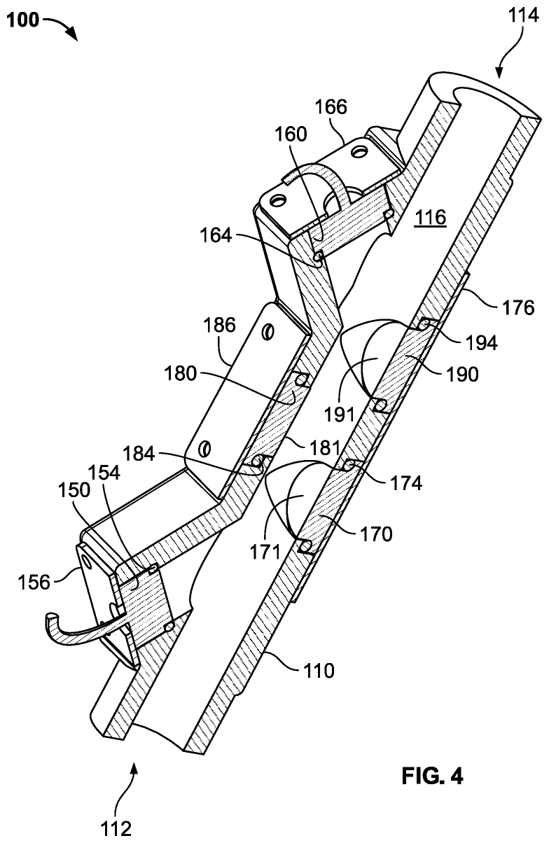

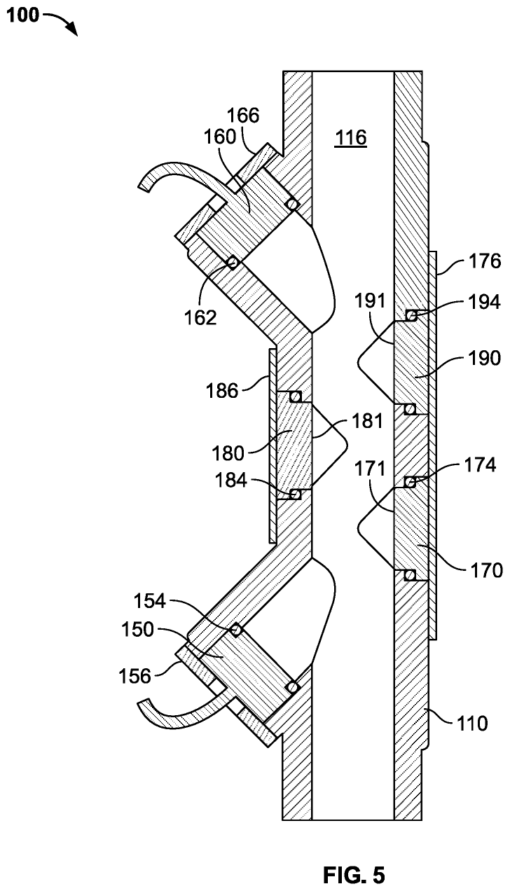

As shown in FIGS. 4-5, the body 110 defines an inlet 112, an outlet 114, and a flow path 116 extending between the inlet 112 and the outlet 114. The flow path 116 of the illustrated example extends in a straight line along a longitudinal axis without any bends, curves, and/or angles between the inlet 112 and the outlet 114. The flow path 116 defined by the body 110 is cylindrically shaped to facilitate the smooth flow of fluid through the flow path 116.

As shown in FIGS. 1-5 and 8, a portion of the body 110 has a polygonal cross-section. In other embodiments, the body may be any cross section, including circular. The body 110 includes a bottom wall 120 (also referred to as a first wall), one or more upper walls 130 (also referred to as one or more second walls), side walls that extend between and are perpendicular to the bottom wall 120 and the upper walls 130, and end walls from which inlet 112 and the outlet 114 extend. In the illustrated example, the upper walls 130 include an inlet-end upper wall 132, an outlet-end upper wall 134, and an intermediate wall 136.

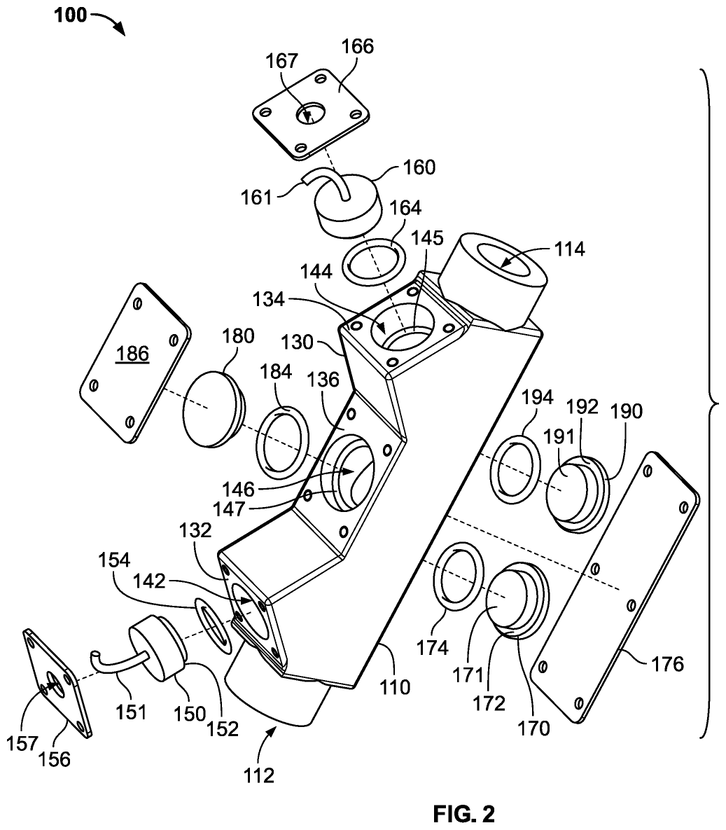

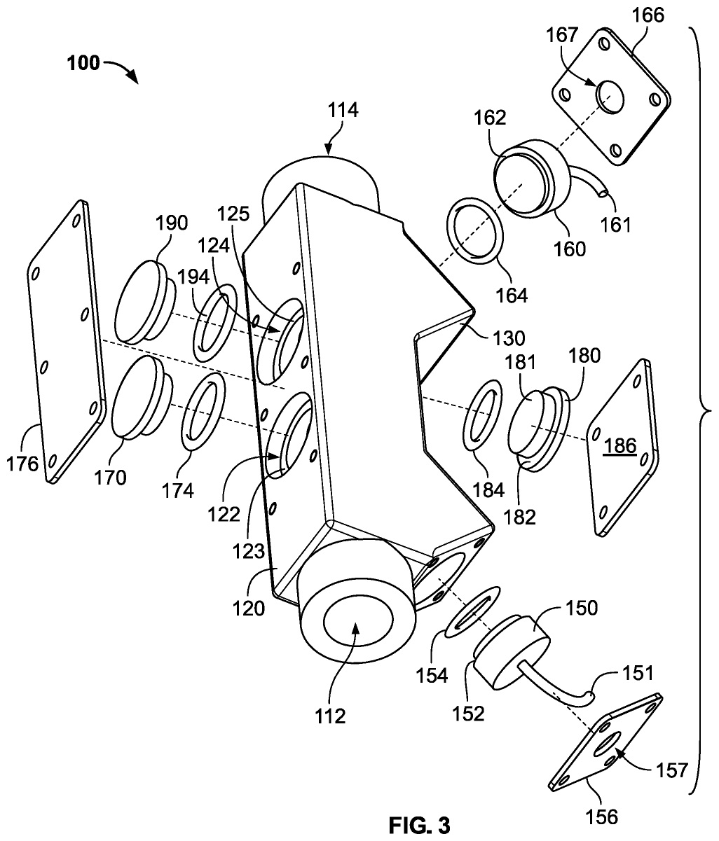

As shown in FIGS. 3-5 and 7-8, the bottom wall 120 extends parallel to the longitudinal axis of the body 110. The bottom wall 120 defines a flat outer surface to enable the body 110 to securely rest on an adjacent object for support. The flat outer surface defined by the bottom wall 120 extends parallel to the longitudinal axis of the body 110. The bottom wall 120 also defines openings 122, 124 that extend to the flow path 116 in a direction perpendicular to the longitudinal axis of the body 110. As disclosed below in greater detail, each of the openings 122, 124 (also referred to as second openings) is configured to sealingly receive the respective reflectors 170, 190. In the illustrated example, the openings 122, 124 are cylindrical to receive cylindrical portions of the reflectors 170, 190. In other examples, the bottom wall 120 defines a single opening that is configured to receive a respective reflector. In such examples, the opening and the respective reflector have a substantially rectangular shape that extends longitudinally along the bottom wall 120. The single bottom reflector is configured to extend between where the reflectors 170, 190 would otherwise be positioned such that the single bottom reflector can function as a replacement for both of the reflectors 170, 190. As shown in FIG. 2, the intermediate wall 136 is positioned between the inlet-end upper wall 132 and the outlet-end upper wall 134. The intermediate wall 136 extends parallel to the longitudinal axis of the body 110 and defines an opening 146 that extends to the flow path 116 in a direction perpendicular to the longitudinal axis. As disclosed below in greater detail, the opening 146 (also referred to as a third opening) is configured to sealingly receive the reflector 180. For example, the opening 146 is cylindrical to receive a cylindrical portion of the reflector 180.

The inlet-end upper wall 132 is adjacent to the inlet 112. The inlet-end upper wall 132 is oriented at an angle (e.g., a 45-degree angle, a 60-degree angle, etc.) relative to the longitudinal axis of the body 110. The inlet-end upper wall 132 defines an opening 142 that extends toward the middle of the flow path 116 at a non-parallel, non-perpendicular angle (e.g., a 45-degree angle, a 60-degree angle, etc.) relative to the longitudinal axis of the body 110. As disclosed below in greater detail, the opening 142 is configured to sealingly receive the transducer 150. For example, the opening 142 is cylindrical to receive a cylindrical portion of the transducer 150.

The outlet-end upper wall 134 is adjacent to the outlet 114. The outlet-end upper wall 134 is oriented at an angle (e.g., a 45-degree angle, a 60-degree angle, etc.) relative to the longitudinal axis of the body 110. The outlet-end upper wall 134 defines an opening 144 that extends toward the middle of the flow path 116 at a non-parallel, non-perpendicular angle (e.g., a 45-degree angle, a 60-degree angle, etc.) relative to the longitudinal axis of the body 110. As disclosed below in greater detail, the opening 144 is configured to sealingly receive the transducer 160. For example, the opening 144 is cylindrical to receive a cylindrical portion of the transducer 160.

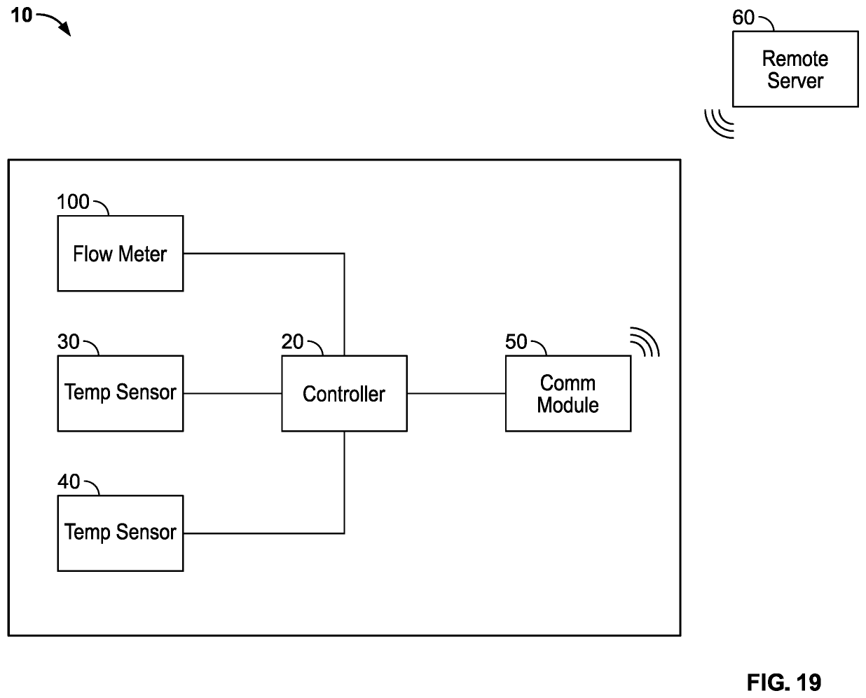

As shown in FIGS. 2-5, the transducer 150 extends into the opening 142 and the transducer 160 extends into the opening 144. The transducers 150, 160 are configured to transmit and receive a signal that travels through the flow path 116 to measure a flow rate of fluid flowing through the flow path 116. The transducers 150, 160 are configured to convert signals from one signal form to another form. For example, one of the transducers 150, 160 is a transmitter that is configured to convert an electrical signal to an ultrasonic signal, and the other of the transducers 150, 160 is a receiver that is configured to convert an ultrasonic signal to an electrical signal. The transmitter is configured to convert an electrical signal into an ultrasonic signal and send the ultrasonic signal to the receiver. The receiver is configured to receive the ultrasonic signal from the received ultrasonic signal to another electrical signal. For example, each of the transducers 150, 160 is configured to vibrate in a respective longitudinal direction to transmit and/or receive ultrasonic signals. As disclosed below in greater detail, a controller (e.g., a controller 20 of FIG. 19) to analyze the electrical signals to measure a flow rate of fluid flowing through the flow path 116. In the illustrated example, each of the transducers 150, 160 is electrically connected to the controller 20 via respective wires 151, 161 to enable the controller 20 to process the electrical signals of the transducers 150, 160.

As shown in FIG. 5, the transducer 150 is oriented at a predefined angle (e.g., a 45-degree angle, a 60-degree angle, etc.) relative to the longitudinal axis of the body 110 when coupled to the body 110 within the opening 142. The transducer 150 is oriented such that the face of the transducer 150 is facing in a direction toward the reflector 170. The transducer 150 is coupled to the body 110 in such an orientation to enable the transducer 150 to transmit a signal that is reflected by the reflector 170 to the reflector 180 and/or to enable the transducer to receive a signal that is reflected by the reflector 170 from the reflector 180. Similarly, the transducer 160 is oriented at a predefined angle (e.g., a 45-degree angle, a 60-degree angle, etc.) relative to the longitudinal axis of the body 110 when coupled to the body 110 within the opening 144. The transducer 160 is oriented such that the face of the transducer 160 is facing in a direction toward the reflector 190. The transducer 160 is coupled to the body 110 in such an orientation to enable the transducer to receive a signal that is reflected by the reflector 190 from the reflector 180 and/or to enable the transducer 160 to transmit a signal that is reflected by the reflector 190 to the reflector 180.

In the illustrated example, the transducers 150, 160 are not positioned within or extend into flow path 116. The transducers 150, 160 are positioned such that the transducers 150, 160 are (1) exposed to the flow path 116 without any intervening structure between the transducers 150, 160 and the flow path 116 and (2) receded from the flow path 116 within the respective openings 142, 144 (also referred to as first openings). The transducers 150, 160 are exposed to the flow path 116 to prevent any intervening object from interfering with the ultrasonic signal. The transducers 150, 160 are receded from the flow path 116 to deter the transducers 150, 160 from being an obstruction that affects the rate of fluid flow through the flow path 116.

As shown in FIGS. 2-5, the flow meter 100 includes seals 154, 164 for the respective transducers 150, 160. The seal 154 (e.g., an O-ring) is configured to form a sealed coupling between the transducer 150 and the body 110, and the seal 164 (e.g., an O-ring) is configured to form a sealed coupling between the transducer 160 and the body 110. When the transducer 150 is coupled to the body 110, the seal 154 is positioned between and engages a lip 152 of the transducer 150 and a lip 143 of the opening 142 to form the sealed coupling. When the transducer 160 is coupled to the body 110, the seal 164 is positioned between and engages a lip 162 of the transducer 160 and a lip 145 of the opening 144 to form the sealed coupling.

The flow meter 100 also includes cover plates 156, 166 for removably coupling the respective transducers 150, 160 to the body 110. The cover plate 156 is configured to couple to the inlet-end upper wall 132 (e.g., via fasteners) to securely enclose the transducer 150 within the opening 142. In the illustrated example, the cover plate 156 defines an opening 157 through which the wire 151 of the transducer 150 is to extend to the controller 20. The cover plate 156 is decouplable from the inlet-end upper wall 132 to enable the transducer 150 to be easily accessed for servicing and/or replacement purposes. Similarly, the cover plate 166 is configured to couple to the outlet-end upper wall 134 (e.g., via fasteners) to securely enclose the transducer 160 within the opening 144. The cover plate 166 defines an opening 167 through which the wire 161 of the transducer 160 is to extend to the controller 20. The cover plate 166 is decouplable from the outlet-end upper wall 134 to enable the transducer 160 to be easily accessed for servicing and/or replacement purposes.

The reflectors 170, 180, 190 of the flow meter 100 are configured to reflect the ultrasonic signal traveling through the flow path 116 to relay the ultrasonic signal between the transducers 150, 160. In the illustrated example, each of the reflectors 170, 180, 190 is positioned between the transducers 150, 160, relative to the longitudinal axis of the body 110, to relay the signal between the transducers 150, 160 in a manner that prevents the signal from intersecting itself and, thus, limits interference of the signal. The reflectors 170, 180, 190 are positioned relative to each other and the transducers 150, 160 such that the reflectors 170, 180, 190 form a W-shaped signal path between the transducers 150, 160. For example, a signal is transmitted from the transducer 150, reflected by the reflector 170, reflected by the reflector 180, reflected by the reflector 190, and received by the transducer 160. Alternatively, a signal is transmitted from the transducer 160, reflected by the reflector 190, reflected by the reflector 180, reflected by the reflector 170, and received by the transducer 150.

As shown in FIG. 2-5, the reflector 170 extends into the opening 122 defined by the bottom wall 120, the reflector 180 extends into the opening 146 defined by the intermediate wall 136 of the upper walls 130, and the reflector 190 extends into the opening 124 defined by the bottom wall 120. Each of the reflectors 170, 180, 190 has a respective flat reflective surface 171, 181, 191 that is configured to reflect the ultrasonic signal in a straight line to impede side bands from being propagated that may otherwise create interference for the signal. The flat reflective surfaces 171, 181, 191 of the reflectors 170, 180, 190 extend parallel to each other and the longitudinal axis of the body 110 to facilitate the orderly relaying of the signal between the transducers 150, 160 in a manner that reduces interference of the signal. As disclosed below in greater detail, each of the reflectors 170, 180, 190 is composed of material (e.g., copper) and has a thickness that prevents the signal from being refracted through the reflectors 170, 180, 190. That is, the reflectors 170, 180, 190 are configured and positioned to fully reflect the signal transmitted between the transducers 150, 160. As previously disclosed, other examples of the flow meter 100 include a single reflector that extends along the bottom wall 120. In such examples, the single bottom reflector defines a single reflective surface that is configured to reflect the signal twice with one reflection being between the transducer 150 and the reflector 180 and the other reflection being between the reflector 180 and the transducer 160.

The reflectors 170, 180, 190 of the illustrated example are not positioned within or extend into flow path 116. The reflectors 170, 180, 190 are positioned such that (1) the flat reflective surfaces 171, 181, 191 are exposed to the flow path 116 without any intervening structure between the reflectors 170, 180, 190 and the flow path 116 and (2) the reflectors 170, 180, 190 are receded from the flow path 116 within the respective openings 122, 146, 124. The flat reflective surfaces 171, 181, 191 are exposed to the flow path 116 to prevent any intervening object from interfering with the reflection of the ultrasonic signal. The reflectors 170, 180, 190 are receded from the flow path 116 to deter the reflectors 170, 180, 190 from being an obstruction that affects the rate of fluid flow through the flow path 116.

The flow meter 100 includes seals 174, 184, 194 for the respective reflectors 170, 180, 190. The seal 174 (e.g., an O-ring) is configured to form a sealed coupling between the reflector 170 and the body 110, the seal 184 (e.g., an O-ring) is configured to form a sealed coupling between the reflector 180 and the body 110, and the seal 194 (e.g., an O-ring) is configured to form a sealed coupling between the reflector 190 and the body 110. When the reflector 170 is coupled to the body 110, the seal 174 is positioned between and engages a lip 172 of the reflector 170 and a lip 123 of the opening 122 to form the sealed coupling. When the reflector 180 is coupled to the body 110, the seal 184 is positioned between and engages a lip 182 of the reflector 180 and a lip 147 of the opening 146 to form the sealed coupling. When the reflector 190 is coupled to the body 110, the seal 194 is positioned between and engages a lip 192 of the reflector 190 and a lip 125 of the opening 124 to form the sealed coupling.

The flow meter 100 includes a cover plate 176 for removably coupling the reflectors 170, 190 to the body 110. The cover plate 176 is configured to couple to the bottom wall 120 (e.g., via fasteners) to securely enclose the reflector 170 within the opening 122 and the reflector 190 within the opening 124. The cover plate 156 is decouplable from the bottom wall 120 to enable the reflectors 170, 190 to be easily accessed for servicing and/or replacement purposes. The cover plate 176 also defines a flat outer surface that enables the flow meter 100 to securely rest on an adjacent object for support. The flow meter 100 also includes a cover plate 186 for removably coupling the reflector 180 to the body 110. The cover plate 186 is configured to couple (e.g., via fasteners) to the intermediate wall 136 of the upper walls 130 to securely enclose the reflector 190 within the opening 146. The cover plate 186 is decouplable from the intermediate wall 136 to enable the reflector 180 to be easily accessed for servicing and/or replacement purposes.

In operation, the ultrasonic signal sent between the transducers 150, 160 is used to determine the flow rate of the fluid flowing through the flow path 116. One of the transducers 150, 160 transmits the signal into the flow path 116 through which the fluid is flowing. The flat reflective surfaces 171, 181, 191 of the reflectors 170, 180, 190 reflect the signal along a W-shaped signal path through the fluid flowing through the flow path 116. The ultrasonic signal travels along the W-shaped such that the signal intersects the longitudinal axis of the body 110 at non-perpendicular angles. Subsequently, the other of the transducers 150, 160 receives the ultrasonic signal. As disclosed below in greater detail, the controller 20 measures the travel time of the ultrasonic signal between the transducers 150, 160. The controller 20 is configured to determine the flow rate of the fluid flowing through the flow path 116 based on, at least in part, the measurement of the travel time of the ultrasonic signal. For example, an advantage of the W-shaped signal path configuration is that low flow rates of approximately 0.5 GPM provide a long signal time, which provides better resolution than prior solutions.

The flow meter 100 of the illustrated example includes the three reflectors 170, 180, 190. In other examples, the flow meter may include less or more reflectors between the transducers 150, 160. For example, the flow meter 100 may include (i) one reflector that forms a V-shaped signal path between the transducers 150, 160 or (ii) five reflectors that form a VVV-shaped signal path between the transducers 150, 160. Alternatively, the flow meter 100 may include two reflectors with one of the transducers 150, 160 positioned along the bottom wall 120 and the other of the transducers 150, 160 positioned along the upper walls 130.

In some instances, a stray waveform may travel directly between the transducers 150, 160 without traveling along the W-shaped signal path within the flow path 116. To prevent such a signal from creating interference that would otherwise affect the measurement of the time travel of the signal, the controller 20 delays the sampling of the signal by the one of the transducers 150, 160 receiving the signal to start a predetermined period of time after the other of the transducers 150, 160 transmits the signals. That is, the controller 20 delays sampling of the ultrasonic signal to prevent other waveforms from affecting the measurement of the ultrasonic signal traveling along the W-shaped signal path in order to facilitate the accurate measurement of the flow rate of fluid flowing through the flow path 116.

FIGS. 10-18 depict another example flow meter 200 in accordance with the teachings herein. The flow meter 200 includes components that are identical and/or substantially similar to respective components of the flow meter 100 of FIGS. 1-9. For example, the flow meter 200 includes a body 210; transducers 250, 260; and reflectors 270, 280, 290 with features similar to those of the body 110; the transducers 150, 160; and reflectors 170, 180, 190 of the flow meter 100. Because components of the flow meter 100 have been described in detail in connection with FIGS. 1-9, some of those features of the flow meter 200 of FIGS. 10-18 that are identical and/or substantially similar to respective features of the flow meter 100 to are not described in further detail below.

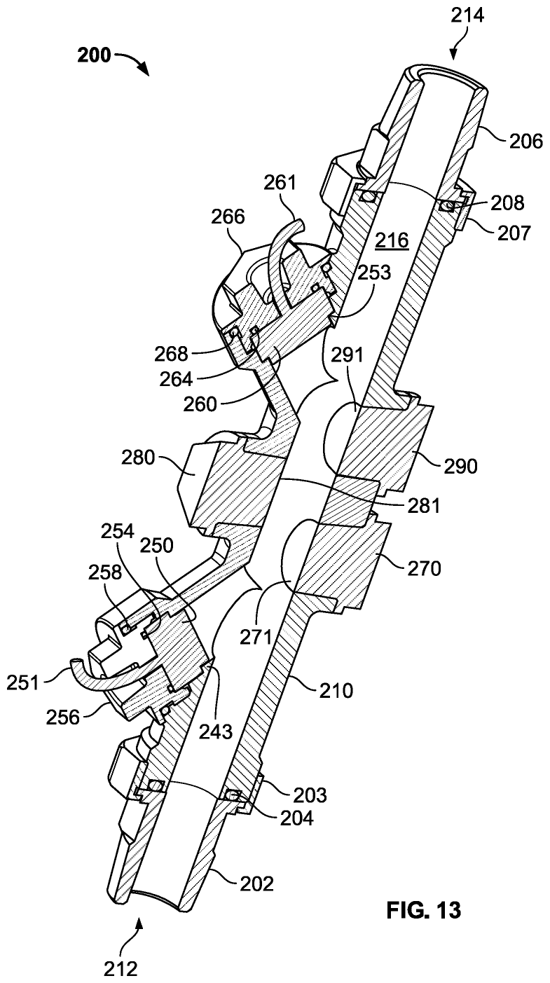

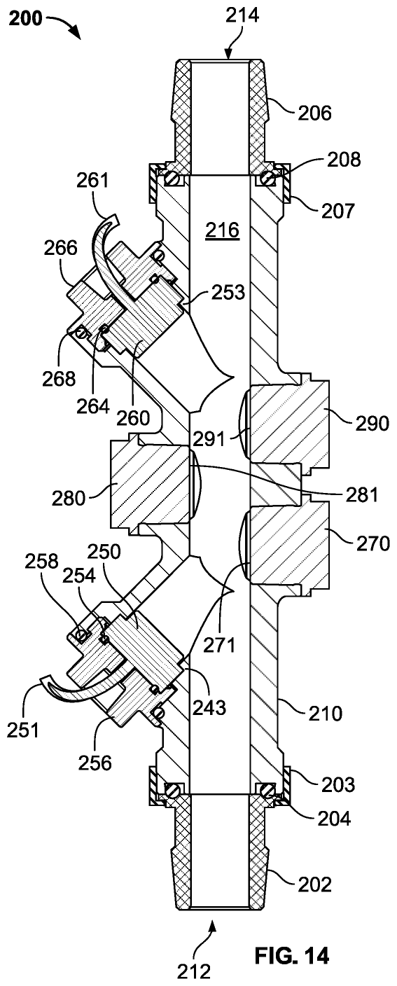

As shown in FIGS. 13 and 14, the body 210 is cylindrical and defines an inlet 212, an outlet 214, and a flow path 216 extending between the inlet 212 and the outlet 214. The flow path 116 of the illustrated example extends in a straight line along a longitudinal axis without any bends, curves, and/or angles between the inlet 212 and the outlet 214. The flow path 216 defined by the body 210 is cylindrically shaped to facilitate the smooth flow of fluid through the flow path 216. Additionally, as shown in FIGS. 10-14 and 17, the body 210 includes a bottom portion 220 (also referred to as a first portion) and an opposing upper portion 230 (also referred to as a second portion).

The flow meter 200 is configured to be inserted within a flow path of a fan coil. For example, the flow meter 200 includes a fitting 202, 206 to securely couple the flow meter 200 to a pipe or tubing of the fan coil. The fitting 202 (also referred to as an inlet-side fitting) is adjacent the inlet 212 of the flow path 216, and the fitting 206 (also referred to as an inlet-side fitting) is adjacent the outlet 214 of the flow path 216. A threaded fastener 203 (e.g., a nut) threadably is configured to fasten the fitting 202 to the body 210, and a threaded fastener 207 (e.g., a nut) threadably is configured to fasten the fitting 206 to the body 210. A seal 204 (e.g., an O-ring) is configured to form a sealed connection between the fitting 202 and the body 210, and a seal 208 (e.g., an O-ring) is configured to form a sealed connection between the fitting 206 and the body 210.

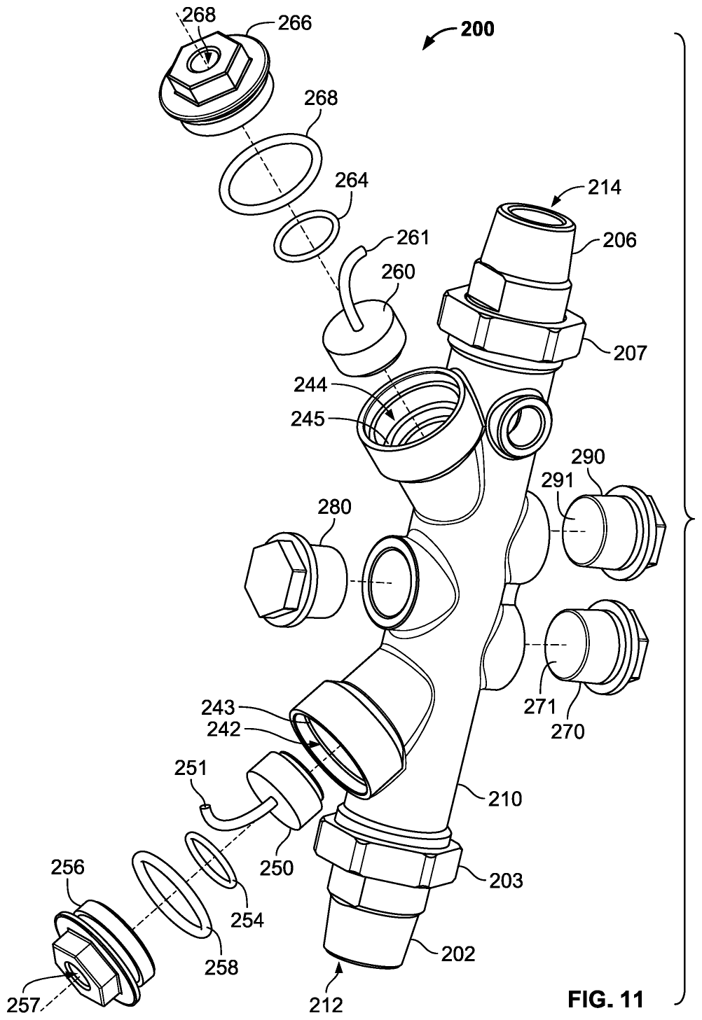

As shown in FIGS. 11-14, the bottom portion 220 of the body 210 defines openings 222, 224 that extend to the flow path 216 in a direction perpendicular to the longitudinal axis of the body 210. As disclosed below in greater detail, each of the openings 222, 224 (also referred to as second openings) is configured to sealingly receive the respective reflectors 270, 290. In the illustrated example, the openings 222, 224 are cylindrical to receive cylindrical portions of the reflectors 270, 290.

The upper portion 230 of the body 210 defines openings 242, 244, 246. As disclosed below in greater detail, the openings 242, 244 (also referred to as first openings) are configured to sealingly receive the transducers 250, 260, and the opening 246 is configured to sealingly receive the reflector 280. In the illustrated example, the openings 242, 244 are cylindrical to receive cylindrical portions of the transducers 250, 260, and the opening 246 is cylindrical to receive a cylindrical portion of the reflector 280. The opening 242 extends toward the middle of the flow path 216 at a non-parallel, non-perpendicular angle (e.g., a 45-degree angle, a 60-degree angle, etc.) relative to the longitudinal axis of the body 210. Additionally, the opening 244 extends toward the middle of the flow path 216 at a non-parallel, non-perpendicular angle (e.g., a 45-degree angle, a 60-degree angle, etc.) relative to the longitudinal axis of the body 210.

The transducers 250, 260 of the illustrated are configured to transmit and receive a signal that travels through the flow path 216 to measure a flow rate of fluid flowing through the flow path 216. One of the transducers 250, 260 is a transmitter that is configured to convert an electrical signal to an ultrasonic signal, and the other of the transducers 250, 260 is a receiver that is configured to convert an ultrasonic signal to an electrical signal. As disclosed below in greater detail, the controller 20 is configured to analyze the electrical signals of the transducers 250, 260 to measure a flow rate of fluid flowing through the flow path 216.

As shown in FIG. 14, the transducer 250 is oriented at a predefined angle (e.g., a 45-degree angle, a 60-degree angle, etc.) relative to the longitudinal axis of the body 210 when coupled to the body 210 within the opening 242. The transducer 250 is oriented such that the face of the transducer 250 is facing in a direction toward the reflector 270. Similarly, the transducer 260 is oriented at a predefined angle (e.g., a 45-degree angle, a 60-degree angle, etc.) relative to the longitudinal axis of the body 210 when coupled to the body 210 within the opening 244. The transducer 260 is oriented such that the face of the transducer 260 is facing in a direction toward the reflector 290.

The transducers 250, 260 are positioned such that the transducers 250, 260 are (1) exposed to the flow path 216 without any intervening structure between the transducers 250, 260 and the flow path 216 and (2) receded from the flow path 216 within the respective openings 242, 244. The transducers 250, 260 are exposed to the flow path 216 to prevent any intervening object from interfering with the ultrasonic signal. The transducers 250, 260 are receded from the flow path 216 to deter the transducers 250, 260 from affecting the flow rate of the fluid flowing through the flow path 216.

As shown in FIGS. 11-14, the flow meter 200 includes seals 254, 264 (e.g., first O-rings); caps 256, 266; and seals 258, 268 (e.g., second O-rings) for the respective transducers 250, 260. The caps 256, 266 are threaded and configured to threadably couple to the body 210 to removably couple the respective transducers 250, 260 to the body 210. For example, the transducer 250 is configured to engage a lip 243 of the opening 242, and the transducer 260 is configured to engage a lip 245 of the opening 244. The cap 256 is configured to threadably couple to the body 210 to securely enclose the transducer 250 within the opening 242, and the cap 266 is configured to threadably couple to the body 210 to securely enclose the transducer 260 within the opening 244. The seal 254 is configured to form a sealed coupling between the transducer 250 and the cap 256, and the seal 258 is configured to form a sealed coupling between the cap 256 and the body 210. Similarly, the seal 264 is configured to form a sealed coupling between the transducer 260 and the cap 266, and the seal 268 is configured to form a sealed coupling between the cap 266 and the body 210. In the illustrated example, the cap 256 defines an opening 257 through which a wire 251 of the transducer 250 extends, and the cap 266 defines an opening 267 through which a wire 261 of the transducer 260 extends. The caps 256, 266 are threadably decouplable from the body 210 to enable the transducers 250, 260 to be easily accessed for servicing and/or replacement purposes.

The reflectors 270, 280, 290 of the flow meter 200 are configured to reflect the ultrasonic signal traveling through the flow path 216 to relay the ultrasonic signal between the transducers 250, 260. For example, the reflectors 270, 280, 290 are positioned between the transducers 250, 260, relative to the longitudinal axis of the body 210, to relay the signal between the transducers 250, 260 in a manner that forms a W-shaped signal path between the transducers 250, 260. An advantage of the W-shaped signal path configuration is that low flow rates provide a long signal time.

As shown in FIG. 11-14, the reflector 270 extends into the opening 122, the reflector 280 extends into the opening 246, and the reflector 290 extends into the opening 224. Each of the reflectors 270, 280, 290 has a respective flat reflective surface 271, 281, 291 that is configured to reflect the ultrasonic signal in a straight line. The flat reflective surfaces 271, 281, 291 extend parallel to each other and the longitudinal axis of the body 210 to facilitate the orderly relaying of the signal between the transducers 250, 260 in a manner that reduces interference of the signal. In the illustrated example, the reflector 270 is threadably received within the opening 246, the reflector 280 is threadably received within the opening 246, and the reflector 290 is threadably received within the opening 224. The reflectors 270, 280, 290 are threadably coupled to the body 210 to enable the reflectors 270, 280, 290 to be easily accessed for servicing and/or replacement purposes.

As disclosed below in greater detail, each of the reflectors 270, 280, 290 is composed of material (e.g., copper) and has a thickness that enables the reflectors 270, 280, 290 to fully reflect the signal transmitted between the transducers 250, 260. The reflectors 270, 280, 290 are positioned such that (1) the flat reflective surfaces 271, 281, 291 are exposed to the flow path 216 without any intervening structure between the reflectors 270, 280, 290 and the flow path 216 and (2) the reflectors 270, 280, 290 are receded from the flow path 216 within the respective openings 222, 246, 224.

FIG. 19 depicts a schematic of an energy metering system 10 that incorporates a flow meter, such as the flow meter 100 or the flow meter 200, to monitor the amount of energy consumed by a fan coil. In the illustrated example, the energy metering system 10 includes the flow meter 100. In other examples, the energy metering system 10 includes the flow meter 200 or any other flow meter that is capable of accurately measuring the flow rate of fluid flowing through the fan coil. The energy metering system 10 also includes the controller 20, a supply-side temperature sensor 30, a return-side temperature sensor 40, a communication module 50, and a remote server 60 (e.g., a cloud-computing server). In some embodiments, energy metering system 10 includes a signal amplifier to boost emitted and/or received transducer signals.

The supply-side temperature sensor 30 (e.g., a resistance temperature sensor) is configured to measure the temperature of fluid being supplied to the fan coil to exchange heat in order to regulate the temperature of air in one or more spaces. The return-side temperature sensor 40 (e.g., a resistance temperature sensor) is configured to measure the temperature of fluid being returned from the fan coil after heat has been exchanged to regulate the temperature of the air the in one or more spaces.

The controller 20 of the illustrated example is communicatively coupled to the transducers 150, 160 of the flow meter 100; the temperature sensors 30, 40; and the communication module 50. The controller 20 is configured to supply a first electronic signal to one of the transducers 150, 160 that instantaneously transduces the first electronic signal into a transmitted ultrasonic signal. The controller 20 also is configured to receive a second electronic signal from the other of the transducers 150, 160 that instantaneously transduced the second electronic signal from a received ultrasonic signal. The controller 20 is configured to (1) identify when the first electronic signal is transmitted, (2) identify when the second electronic signal is received, (3) determine the travel time of the ultrasonic signal by comparing time stamps of the first and second electronic signals, and (4) determine the fluid flow rate based on the travel time of the ultrasonic signal. Additionally, the controller 20 is configured to determine the amount of energy consumption rate of the fan coil based on the fluid flow rate, the supply-side fluid temperature, and the return-side fluid temperature.

In some examples, the controller 20 is a metering board with circuits, resistors, diodes, and other electrical components. In other examples, the controller 20 includes a processor and memory. The processor may include any suitable processing device or set of processing devices such as, but not limited to, a microprocessor. The memory may include volatile memory, non-volatile memory, unalterable memory, read-only memory, and/or combinations thereof. The memory is computer readable media on which one or more sets of instructions can be embedded. The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The communication module 50 include hardware (e.g., processor(s), memory, storage, antenna(s), etc.), software, and wired and/or wireless network interface(s) to enable the controller 20 to communicate with other server(s), device(s) and/or network(s). As used herein, a “communication module” refers to hardware with circuitry to provide communication capabilities. For example, the communication module 50 includes wired or wireless network interfaces to enable communication with other devices and/or external networks (e.g., the remote server 60). Example external network(s) include a public network, such as the Internet; a private network, such as an intranet; or combinations thereof, and utilize one or more networking protocol(s) for communication. For example, the communication module 50 enables the controller 20 to transmit, in real time, flow rate and/or energy consumption data to the remote server 60 via wired and/or wireless communication. The remote server 60 is configured to (1) store the data of the energy metering system 10 and (2) generate and distribute reports (e.g., billing reports) of the data, for example, via a web-based portal and/or app.

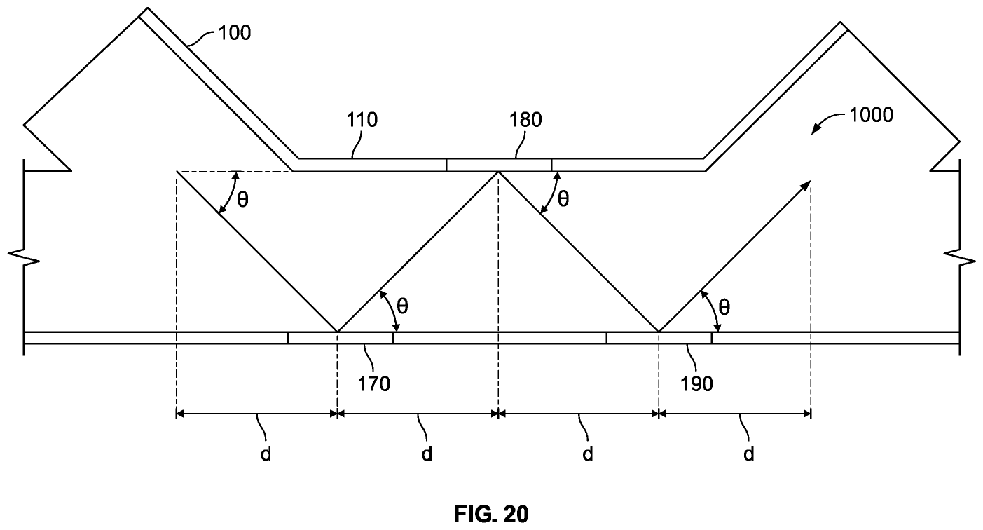

FIG. 20 is a diagram of a W-shaped signal path 1000 of the flow meter 100 used to measure a flow rate of fluid flowing through a fan coil. In the illustrated example, the body 110 is formed of plastic and the reflectors 170, 180, 190 are formed of copper. The body 110 is formed of plastic, metal and/or other material materials that fit connection pipes and environmental temperature conditions. As disclosed below in greater detail, copper provides improved reflective characteristics for ultrasonic signals. The reflectors 170, 180, 190 are configured to be inserts for the body 110 to enable the reflectors 170, 180, 190 to provide the same improved reflective characteristics with different flow meter bodies of different compositions (e.g., plastic, metal, etc.). In other examples, the reflectors 170, 180, 190 may be formed of any material capable of reflecting ultrasonic signals in an accurately measurable manner and/or the body 110 may be formed of any material capable of enabling fluid to flow without affecting characteristics of the fluid and/or the fluid flow.

The calculations performed by the controller 20 to accurately determine the fluid flow are based on (1) the positioning and orientation of the transducers 150, 160; (1) the quantity and positioning of the reflectors 170, 180, 190; (3) the thickness and composition of the reflectors 170, 180, 190; and(4) the fluid type.

In the illustrated example, the fluid is water and the reflectors 170, 180, 190 are copper. The transducers 150, 160 are positioned and oriented the reflectors 170, 180, 190 are positioned relative to the transducers 150, 160 to enable that the reflectors 170, 180, 190 fully reflect the ultrasonic signal without permitting refracted ultrasonic rays through the reflectors 170, 180, 190. For example, the transducers 150, 160 and the reflectors 170, 180, 190 are positioned and oriented such that ultrasonic signal reflects off the reflectors 170, 180, 190 that is greater than the critical angle for reflection. Equation 1, which is based on Snell's law and is provided below, is used to determine the reflection angle.

$$θ > {sin}^{- 1} \frac{{V}_{1}}{{V}_{2}} sin 90 \qquad Equation 1$$

In Equation 1, θrepresents the reflection angle, V₁ represents the speed of sound through the fluid, and V₂ represents the speed of sound through the material of the reflectors. When the fluid is water and the reflectors 170, 180, 190 are formed of copper, the reflection angle must be greater than about 19 degrees. In the illustrated example of FIG. 20, the reflection angle is 45 degrees.

The material of the reflectors 170, 180, 190 reduces the total energy loss of the ultrasonic signal travelling between the transducers 150, 160. Equation 2 provided below is used to determine the energy loss of the signal.

$$Δ E = 1 - {R}^{n} = 1 - {( {[ \frac{{z}_{2} - {z}_{1}}{{z}_{2} + {z}_{1}} ]}^{2} )}^{n} \qquad Equation 2$$

In Equation 2, ΔE represents the total energy loss, z₁ represents the acoustic impedance of the fluid flowing through the flow path 116, z₂ represents the acoustic impedance of the material reflecting the ultrasonic signal, and n represents the number of reflections. When the fluid is water and the reflectors 170, 180, 190 are formed of copper, the total energy loss is about 39%. In contrast, when the fluid is water and the ultrasonic signal is to reflect off of plastic (e.g., of the body 110) the total energy loss is about 81%, thereby making it more difficult to accurately measure characteristics of the ultrasonic signal.

The wall thickness of the reflectors 170, 180, 190 of the illustrated example impedes the creation of destructive waves that may otherwise affect the measurements of the characteristics of the ultrasonic signal. For example, the wall thickness of the reflectors 170, 180, 190 is greater than a quarter wavelength of the ultrasonic signal to deter destructive waves from being formed. total energy loss of the ultrasonic signal travelling between the transducers 150, 160. Equation 3 provided below is used to determine the wall thickness of the reflectors 170, 180, 190.

$$T > \frac{λ}{4} = \frac{{V}_{2}}{4 f} \qquad Equation 3$$

In Equation 3, T represents the wall thickness of the reflectors, V₂ represents the speed of sound through the material of the reflectors, and f represents the frequency of the ultrasonic signal. When the reflectors 170, 180, 190 are formed of copper and the ultrasonic signal is generated by a 1 MHz transducer, the wall thickness of the reflectors 170, 180, 190 must be greater than about 0.045 inches. In the illustrated example, the reflectors 170, 180, 190 have a wall thickness of about 0.080 inches.

Provided below is Equation 4, which is used by the controller 20 to determine the flow rate of the fluid based on known and measured characteristics of the flow meter 100.

$$v = \frac{Δ t \times {V}_{1}^{2}}{( n + 1 ) \times d \times tan θ} \qquad Equation 4$$

In Equation 4, v represents the calculated flow rate, Δt represents the time of the ultrasonic signal between the transducers, V₁ represents the speed of sound travelling through the fluid, n represents the number of reflections, d represents the longitudinal distance between reflections, and θ represents the reflection angle. In the illustrated example, V₁ is the speed of sound through water, n is 3, d is 2.06 inches, and θ is 45 degrees.

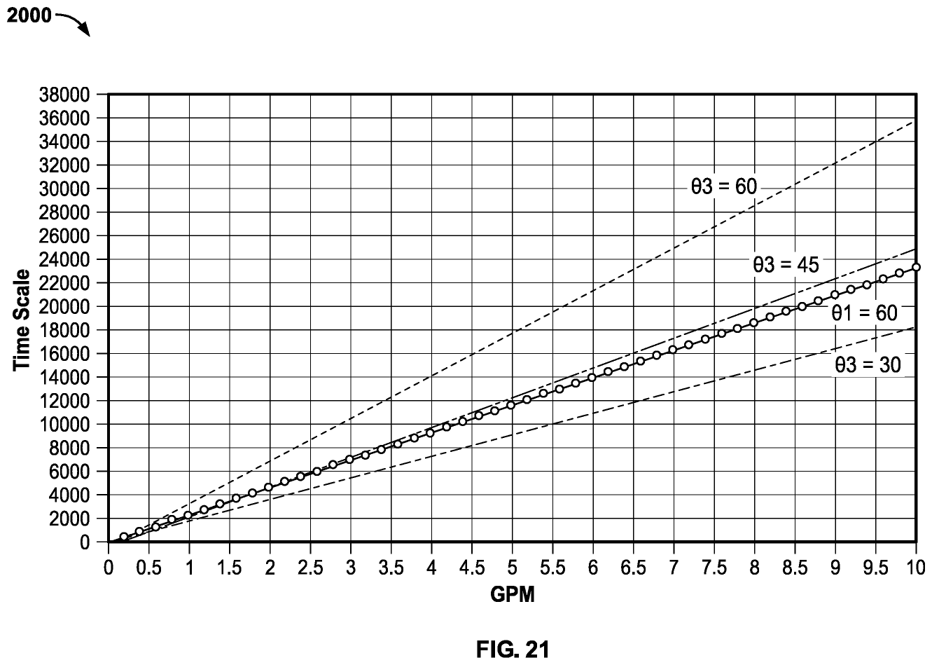

FIG. 21 is a chart 2000 depicting measurement resolutions of various flow meter configurations. The x-axis of the chart 2000 represents a flow rate measured in gallons per minute (GPM), and the y-axis of the chart 2000 represents a time scale of the travel time of measured signal. The chart 2000 includes data for (1) a first signal path with three reflection points each at a 60 degree angle, (2) a second signal path with three reflection points each at a 45 degree angle, (3) a third signal path with one reflection point at a 60 degree angle, and (4) a fourth signal path with three reflection points each at a 30 degree angle. As shown in FIG. 21, the first signal path has a greater resolution than the second signal path, the second signal path has a greater resolution than the third signal path, and the third signal path has a greater resolution than the fourth signal path. Additionally, the signal strength of an ultrasonic wave attenuates as the travel distance increases and/or the number of reflection points increase. Embodiments of energy metering system 10 of the instant disclosure enables no greater than about 8% error between the measured fluid flow rates and the actual flow rate of the fluid at the flow meter.

While specific embodiments have been described in detail, it will be appreciated by those skilled in the art that various modifications and alternatives to those details could be developed in light of the overall teachings of the disclosure. Accordingly, the disclosure herein is meant to be illustrative only and not limiting as to its scope and should be given the full breadth of the appended claims and any equivalents thereof.

What is claimed is:

1. A flow meter for a fan coil, the flow meter comprising:
a body that defines an inlet, an outlet, and a flow path extending along a longitudinal axis between the inlet and the outlet;
transducers coupled to the body and exposed to the flow path defined by the body, the transducers configured to transmit and receive a signal travelling through the flow path to measure a flow rate of fluid of the fan coil; and
one or more reflectors coupled to the body and exposed to the flow path defined by the body, each of the one or more reflectors has a flat reflective surface that is exposed to the flow path and is configured to reflect the signal to relay the signal between the transducers.

2. The flow meter of claim 1, wherein the signal transmitted and received by the transducers is an ultrasonic signal.

3. The flow meter of claim 1, wherein the transducers include a transmitter and a receiver, wherein the transmitter is configured to transmit the signal in a direction toward a first of the one or more reflectors, wherein the receiver is configured to receive the signal reflected by each of the one or more reflectors.

4. The flow meter of claim 1, further comprising a controller in communication with the transducers, wherein the controller is configured to determine the flow rate of the fluid based on a measurement of a travel time of the signal between the transducers.

5. The flow meter of claim 4, wherein, to prevent interference from affecting the measurement of the travel time of the signal, the controller is configured to delay sampling of the signal by a first of the transducers to start a predetermined period of time after a second of the transducers sends the transmits the signal.

6. The flow meter of claim 1, wherein the flat reflective surface of each of the one or more reflectors extends parallel to the longitudinal axis of the body.

7. The flow meter of claim 1, wherein each of the transducers is oriented at a predefined angle relative to the longitudinal axis, and wherein the predefined angle of each of the transducers is based on the material composition of the fluid and the one or more reflectors to enable total internal reflection of the signal off each of the one or more reflectors.

8. The flow meter of claim 7, wherein each of the one or more reflectors is formed of copper and the predefined angle at which each of the transducers is oriented is greater than about 45 degrees.

9. The flow meter of claim 1, wherein the one or more reflectors include three reflectors each of which is positioned between the transducers relative to the longitudinal axis, and wherein the three reflectors are configured to reflect the signal in sequence to form a W-shaped signal path of the signal between the transducers.

10. The flow meter of claim 1, wherein none of the transducers and none of the one or more reflectors are positioned within or extend into the flow path defined by the body.

11. A flow meter for a fan coil, the flow meter comprising:
a body that defines an inlet, an outlet, a flow path extending along a longitudinal axis between the inlet and the outlet, transducer openings, and reflector openings;
transducers positioned within the transducer openings to expose the transducers to the flow path defined by the body, the transducers being removably coupled to the body, the transducers being configured to transmit and receive a signal travelling through the flow path to measure a flow rate of fluid of the fan coil;
reflectors positioned within the reflector openings to expose the reflectors to the flow path defined by the body, the reflectors being removably coupled to the body, each of the reflectors having a flat reflective surface that is exposed to the flow path and is configured to reflect the signal to relay the signal between the transducers; and
plates removably coupled to the body to removably couple the transducers and the reflectors to the body.

12. The flow meter of claim 11, further comprising seals each of which is configured to form a sealed coupling between the body and one of the transducers or one of the reflectors.

13. The flow meter of claim 11, wherein at least one of the plates defines a flat outer surface to enable the body to securely rest on an adjacent object for support.

14. The flow meter of claim 11, wherein the body further includes a first wall and second walls opposite the first wall, wherein the second walls define the transducer openings.

15. The flow meter of claim 14, wherein the first wall defines two of the reflector openings into which two of the reflectors extend and the second walls define one of the reflector openings, and wherein the reflectors include three reflectors that are positioned relative to the transducers to form a W-shaped signal path of the signal between the transducers.

16. The flow meter of claim 14, wherein the plates include first and second plates configured to couple the transducers to respective walls of the second walls.

17. The flow meter of claim 16, wherein the plates include:
a third plate configured to couple one of the reflectors to a respective one of the second walls; and
a fourth plate configured to couple two of the reflectors to the first wall.
